(19) United States
(12) Patent Application Publication
(10) Pub. No.: US 2012/0137359 A1
(43) Pub. Date: May 31, 2012

(54) Method For Storing (Hiding) A Key In A Table And Corresponding Method For Retrieving The Key From The Table

(75) Inventor: Hector SZABO, Quebec City (CA)

(73) Assignee: GROUPE CGI INC., Montreal (CA)

(21) Appl. No.: 13/305,696

(22) Filed: Nov. 28, 2011

Related U.S. Application Data
(60) Provisional application No. 61/417,866, filed on Nov. 29, 2010.

(51) Int. Cl. H04L 9/32

(52) U.S. Cl. 726/16; 726/2; 380/277

(57) ABSTRACT

A method is provided for storing/retrieving a key in a table, the method for storing a key comprising providing a table comprising a plurality of entries, each selected from a group consisting of random words and random strings; providing a question to a user; receiving from the user a corresponding secret answer; receiving the key to store in the table; determining a position in the table using the received corresponding secret answer and at least one table entry and storing the key at the determined position.

### CROSS-REFERENCE TO RELATED APPLICATIONS

This application claims priority of U.S. provisional patent application No. 61/417,866 entitled “METHOD FOR STORING (HIDING) A KEY IN A TABLE AND CORRESPONDING METHOD FOR RETRIEVING THE KEY FROM THE TABLE” that was filed on Nov. 29, 2010, the specification of which is hereby incorporated by reference.

### FIELD OF THE INVENTION

The invention relates to data encryption. More precisely, the invention pertains to a method for storing (hiding) a key in a table and an associated method for retrieving the key from the table.

### BACKGROUND

Conservation and memorization of passwords and secret keys are a very common task. It is desirable to memorize the secret keys or to store them in a secure place.

Security requirements required to produce complex keys, to change them after short periods of time and to not repeat the keys, turning key memorization a hard task. Dealing with multiple keys in different systems with their own rules increases the problem.

The skilled addressee will appreciate that failure to safely store the secret key may therefore compromise authentication and access control to a system, premise or resource.

One solution is to use a document which will be used to store the user secret key.

Unfortunately it may be easy to process the document to extract the key based on semantic analysis for instance if the key is not properly hidden.

Other drawbacks for storing keys in documents are related to hiding logic. Dictionary based force brute attacks upon documents will expose a large amount of unintelligible returns. When the algorithm returns contents existing in a reference dictionary, the result is tested as a key candidate. Reverse engineering techniques combined with brute force attacks can expose hidden key when changes in the sequence of instructions executed exposes a hit on the key. Those processes can be largely automated, allowing low-cost effort to unhide a key.

There is a need for a method for storing a key in a document that will overcome at least one of the above-identified drawbacks.

Features of the invention will be apparent from review of the disclosure, drawings and description of the invention below.

### BRIEF SUMMARY

According to one embodiment, there is provided a method for storing a key in a table, the method comprising providing a table comprising a plurality of entries, each selected from a group consisting of random words and random strings; providing a question to a user; receiving from the user a corresponding secret answer; receiving the key to store in the table; determining a position in the table using the received corresponding secret answer and at least one table entry; and storing the key at the determined position.

An advantage of the invention is that using the method disclosed herein a table may be used to efficiently obfuscate a key.

Another advantage of the invention is that when retrieving a key from the table, a user may obtain a plausible fake key if a proper answer to a secret question is not provided.

In accordance with an embodiment, the key is used as a password to grant access to a system.

In accordance with yet another embodiment, the key is used for encrypting a message according to a private key encryption system.

In yet another embodiment, the key comprises a sequence of characters.

In yet another embodiment, each entry of the plurality of entries is selected from a group consisting of random words and random strings.

In yet another embodiment, each entry of the plurality of entries is selected from a group consisting of syllabi and phonemes of at least one language

In accordance with yet another embodiment, the method further comprises normalizing the received secret answer, further wherein the position in the table is determined using the normalized received corresponding answer and at least one table entry.

In yet another embodiment, the normalizing of the received secret answer comprises at least one of setting a unique case; reducing spaces, blank characters and uncommon characters to one space and substituting common expressions in the received secret answer.

In yet another embodiment, the normalizing of the secret answer comprises at least one word substitution, allowing the user to do some common grammar or spelling mistakes when writing the answer, the substitution algorithm giving the same normalized text for a syntactically correct or misspelled answer.

In yet another embodiment, the normalizing of the secret answer comprises at least one word substitution, allowing the user to refer elements which change its names along the time (i.e. Road becoming Boulevard), allowing time resilience for user answers, the substitution algorithm giving the same normalized text for an old or new denomination.

In yet another embodiment, the key to store in the table is received by a user.

In yet another embodiment, the key to store in the table is received from an application.

In accordance with an embodiment, the determining of the position in the table comprises determining a table cell; producing a digest using the corresponding secret answer and content located in the determined table cell; and using the digest to calculate the position.

In accordance with another embodiment of the method, a plurality of positions are calculated using the digest, further comprising breaking the key to store in a plurality of key fragments, each of the plurality of key fragments being stored in a corresponding position of the plurality of position.

In accordance with another embodiment of the method, a plurality of questions are provided to a user; a plurality of corresponding secret answers are received from the user; a plurality of positions are determined in the table, each using at least one received corresponding secret answer and at least one entry; further comprising breaking the key to store in a plurality of key fragments, each of the plurality of key fragment being stored in a corresponding position of the plurality of positions.

In accordance with another embodiment, the questions and corresponding answers are substituted with biometric data provided by a corresponding biometric reader, the biometric data being used to produce a digest, combined with the content located in a determined table cell; and using the digest to calculate the position. In accordance with another embodiment, there is provided a method for retrieving a key from a table, the method comprising obtaining a table generated in accordance with the method claimed above, the method comprising providing the question to a user; receiving from the user a corresponding secret answer; determining a position in the table using the received corresponding secret answer and at least one table entry of the table generated and retrieving the key at the determined position.

In accordance with another embodiment, there is provided a method for retrieving a key from a table, the method comprising obtaining a table generated in accordance with the method disclosed above, the method comprising providing the question to a user; receiving from the user a corresponding secret answer; normalizing the corresponding secret answer; determining a position in the table using the corresponding normalized secret answer and at least one table entry of the table generated and retrieving the key at the determined position.

In accordance with another embodiment, there is disclosed a method for retrieving a key from a table, the method comprising obtaining a table generated in accordance with a method disclosed above, the method comprising providing the plurality of questions to the user; receiving from the user a corresponding plurality of secret answers; determining a plurality of positions in the table using the corresponding plurality of secret answers and at least one entry on the table; retrieving a part of the key at each of the plurality of positions and combining each part of the key to provide the key.

In accordance with an embodiment, there is provided a computing device, comprising a display device; a central processing unit; a memory comprising an application, wherein the application is configured to be executed by the central processing unit, the application comprising instructions for providing a table comprising a plurality of entries, each selected from a group consisting of random words and random strings;

instructions for providing a question to a user; instructions for receiving from the user a corresponding secret answer; instructions for receiving the key to store in the table; instructions for determining a position in the table using the received corresponding secret answer and at least one table entry; and instructions for storing the key at the determined position.

In accordance with an embodiment the secret answer comprises at least one of a corresponding response to the question and user biometric data.

In accordance with another embodiment, the secret answer comprises user biometric data, further wherein the user biometric data is selected from a group consisting of fingerprint data, iris data and typing pattern data.

In accordance with another embodiment, each of the plurality of corresponding secret answers comprises at least one of a corresponding response to a corresponding question and user biometric data.

### BRIEF DESCRIPTION OF THE DRAWINGS

In order that the invention may be readily understood, embodiments of the invention are illustrated by way of example in the accompanying drawings.

FIG. 1 is a flowchart which shows a first embodiment of a method for storing a key in a table.

FIG. 2 is a flowchart which shows a first embodiment of a method for retrieving a key from a table.

FIG. 3 is a flowchart which shows another embodiment of a method for storing a key in a table.

FIG. 4 is flowchart which shows another embodiment of a method for retrieving a key from a table.

FIG. 5 is a block diagram which shows an embodiment of a processing unit in which the methods disclosed above may be implemented.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

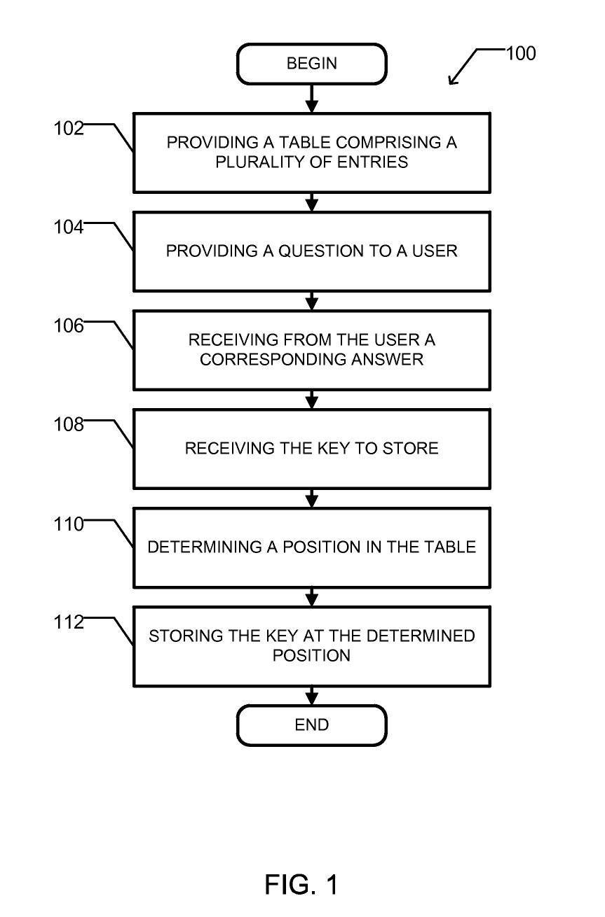

Now referring to FIG. 1, there is shown an embodiment 100 of a method for storing a key in a table. It will be appreciated that the key may be used for various purposes. In one embodiment, the key is used as a password to grant access to a system. In other embodiment, the key is used for encrypting a message according to a private key encryption scheme.

Moreover, it will be appreciated that the key may be of various types. For instance the key comprises a sequence of characters. In a preferred embodiment, the key comprises memorable information combined to produce a password or first letters of a phrase. Embodiment supports user tendency to use very simple passwords nonetheless.

According to processing step 102, a table comprising a plurality of entries is provided. It will be appreciated that each entry is selected from a group consisting of random words and random strings. It will be appreciated that each entry of the plurality of entries may alternatively be one of a syllable and a phoneme of at least one language. The skilled addressee will appreciate that the size of the table must be variable depending on external arbitrary random calculations. Robustness to attacks requires hundreds of table entries denying a casual recovery of the key. In a preferred embodiment, table size is affected by key size.

According to processing step 104, a question is provided to a user. It will be appreciated that the question is a secret question. It will be appreciated by the skilled addressee that the question may be selected by the user depending on various parameters. In fact, a user may wish to select a given question more than another.

According to processing step 106, a corresponding answer is received from the user. The skilled addressee will appreciate that the corresponding answer is related to the question provided to the user in processing step 104.

It will be appreciated that in an alternative embodiment the secret answer comprises at least one of a corresponding response to the question and a user biometric data. Moreover it will be appreciated that the user biometric data may be selected from a group consisting of fingerprint data, iris data, and typing patterns data. The skilled addressee will appreciate that alternative embodiments may be possible for the user biometric data.

According to an optional processing step not shown in FIG. 1, the corresponding answer related to the question is normalized. It will be appreciated that the normalization is performed in order to reduce the impact of for instance text case changes, spacing, common orthographic errors and abbreviations which could change the answer. In a preferred embodiment, the normalization comprises the processing steps of setting a unique case, reduce spaces, blank characters and uncommon characters to one space each, followed by the substitution of common expressions to an unique form (i.e. street could be st or street. Both are replaced by street). It will be appreciated that in an alternative embodiment, the normalizing of the corresponding answer comprises at least one word substitution. The at least one word substitution may allow the user to do some common grammar or spelling mistakes when writing the answer. The substitution algorithm gives the same normalized text for a syntactically correct or misspelled answer. In an alternative embodiment, the normalizing of the corresponding answer comprises at least one word substitution allowing the user to refer to elements which change its name along the time (e.g. a road becoming a boulevard), allowing time resilience for user answers. In such embodiment, the substitution algorithm will give the same normalized text for an old or a new denomination which may be of great advantage.

According to processing step 108, a key to store is received. As mentioned above, the key to store may be of various types. It will be appreciated that the key to store may be provided by a user directly. Alternatively, the key to store may be provided by an application for instance.

According to processing step 110, a “hash position” is determined in the table [1]. The position is determined based on the corresponding answer, or the normalized answer if a normalization is performed on the corresponding answer and at least one entry of the table.

In a preferred embodiment, the position is determined according to the following algorithm: a digest is produced from the secret answer and the contents of a calculated table cell. This digest is used to calculate one hash position to store the secret key. Hashing algorithm resolves possible collisions with the cell occupied by the key or other cells used in calculations. Each written position is marked and any further access to that cell will trigger the use of next free cell. This is referred to as circular progressive overflow technique and is disclosed for instance by Donald E. Knuth, “The art of computer programming, 3: Sorting and Searching”, (2^{nd} Ed.); Addison-Wesley, pp 513-558, (1998).

According to processing step 112, the key is stored at the determined position in the table. Randomly selected positions can also be used to store multiple copies of the key as clutter in the table, hiding its uniqueness.

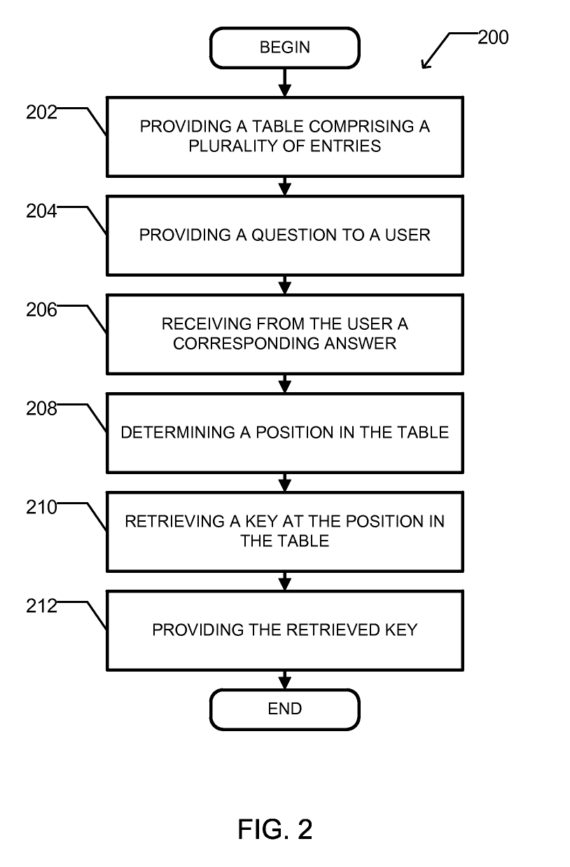

Now referring to FIG. 2, there is shown an embodiment of a method for retrieving a key from a table.

According to processing step 202, the same table referred in processing step 102 comprising a plurality of entries is provided.

According to processing step 204, the same question proposed in processing step 104 is provided to a user.

According to processing step 206, a corresponding answer is received from the user. The skilled addressee will appreciate that the corresponding answer is related to the question provided to the user in processing step 204 and must be equal to answer provided in step 106.

According to an optional processing step, not shown in FIG. 2, the corresponding answer related to the question is normalized. It will be appreciated by the skilled addressee that the algorithm used is similar to the algorithm disclosed above.

According to processing step 208, a recovery hash position is determined in the table using an algorithm similar to the algorithm disclosed above in processing step 110.

In a preferred embodiment, the position is determined according to the following algorithm: a digest is produced from the secret answer; and the contents of a calculated table cell. This digest is used to calculate one or many hash positions to recover the secret key. Hashing algorithm resolves possible collisions with key or other cells used in calculations. Each read position is marked and any further access to that cell will trigger the use of next free cell (circular progressive overflow technique). It will be appreciated by the skilled addressee the algorithm used is similar to the algorithm used for determining the position at processing step 110.

According to processing step 210, the key is retrieved at the determined position in the table.

According to processing step 212, the retrieved key is provided. The skilled addressee will appreciate that even a bad answer will return a key and that this key will be a “lure key”. If used, this lure key will trigger standard security mechanisms blocking attacker access after few tries. The skilled addressee will appreciate that the algorithm will not expose a different logic if a bad answer is provided and a lure key is calculated. The skilled addressee will appreciate that a legitimate user who gives a wrong answer could recognize more easily the returned value as an alien key, preventing its use.

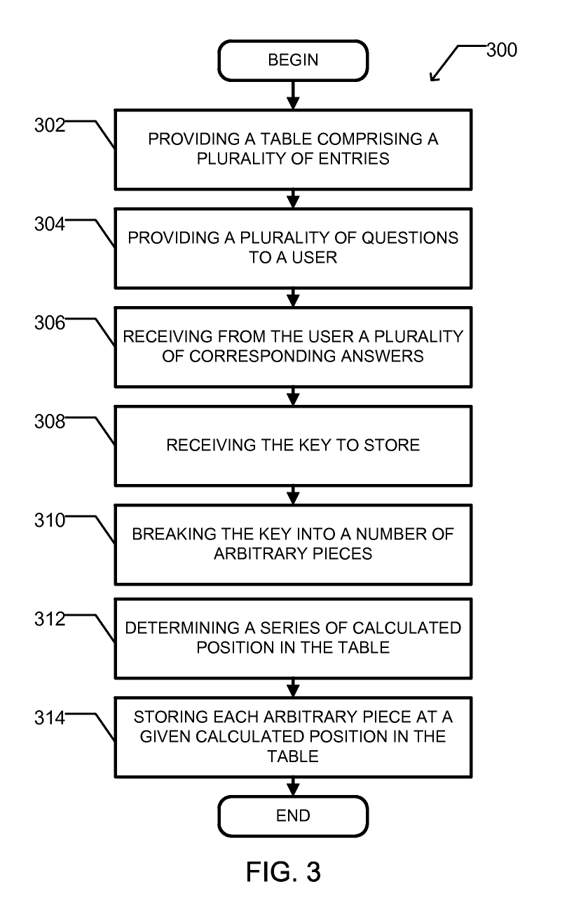

Now referring to FIG. 3, there is shown another embodiment of a method 300 for storing a key in a table.

According to processing step 302, a table comprising a plurality of entries is provided. It will be appreciated that each entry is selected from a group consisting of random words and random strings. The skilled addressee will appreciate that the size of the table must be variable depending on external arbitrary random calculations. Robustness to attacks requires hundreds of table entries denying a casual key recovery of all key segments. In a preferred embodiment, table size is affected by key size.

According to processing step 304, a plurality of questions is provided. It will be appreciated that each question of the plurality of questions is a secret question. It will be appreciated by the skilled addressee that each question may be selected by the user depending on various parameters. In fact, a user may wish to select a given question more than another.

According to processing step 306, a plurality of corresponding answers is received from the user. The skilled addressee will appreciate that each corresponding answer is related to a corresponding question provided to the user in processing step 304.

According to an optional processing step, not shown in FIG. 3, each corresponding answer related to a corresponding question is normalized. It will be appreciated that the normalization is performed in order to reduce for instance the impact of text case changes, spacing, common orthographic errors and abbreviations which could change the answer. In a preferred embodiment, the normalization comprises setting a unique case, reduce spaces, blank characters and uncommon characters to one space each, followed by the substitution of common expressions to an unique form (i.e. street could be st or street. Both are replaced by street. It will be appreciated that in an alternative embodiment, the normalizing of the corresponding answer comprises at least one word substitution. The at least one word substitution may allow the user to do some common grammar or spelling mistakes when writing the answer. The substitution algorithm gives the same normalized text for a syntactically correct or misspelled answer. In an alternative embodiment, the normalizing of the corresponding answer comprises at least one word substitution allowing the user to refer to elements which change its name along the time (e.g. a road becoming a boulevard), allowing time resilience for user answers. In such embodiment, the substitution algorithm will give the same normalized text for an old or a new denomination which may be of great advantage.

According to processing step 308, the key to store is received. It will be appreciated that the key to store is received from the user in one embodiment. Alternatively, the key to store may be provided by an application for instance.

According to processing step 310, the key is broken into a number of arbitrary pieces. The number of arbitrary pieces is determined by key structure. In fact, the skilled addressee will appreciate that the breaking of the key into a number of pieces is unrelated to the number of secret questions of the plurality of secret questions.

According to processing step 312, a series of calculated hash positions is determined. In a preferred embodiment, the position is determined according to the following algorithm: a digest is produced from the secrets answers and the contents of a calculated table cell. This digest is used to calculate a series of hash positions to store the secret key fragments. Hashing algorithm resolves possible collisions with cells occupied by key fragments or other cells used in calculations. Each written position is marked and any further access to that cell will trigger the use of next free cell. This is referred to as circular progressive overflow technique and is disclosed by Donald E. Knuth, “The art of computer programming, 3: Sorting and Searching”, (2^{nd} Ed.); Addison-Wesley, pp 513-558, (1998)).

According to processing step 314, each arbitrary piece is stored at a given calculated position in the table. Randomly selected positions are also used to store multiple copies of each key fragment as clutter in the table, hiding its uniqueness.

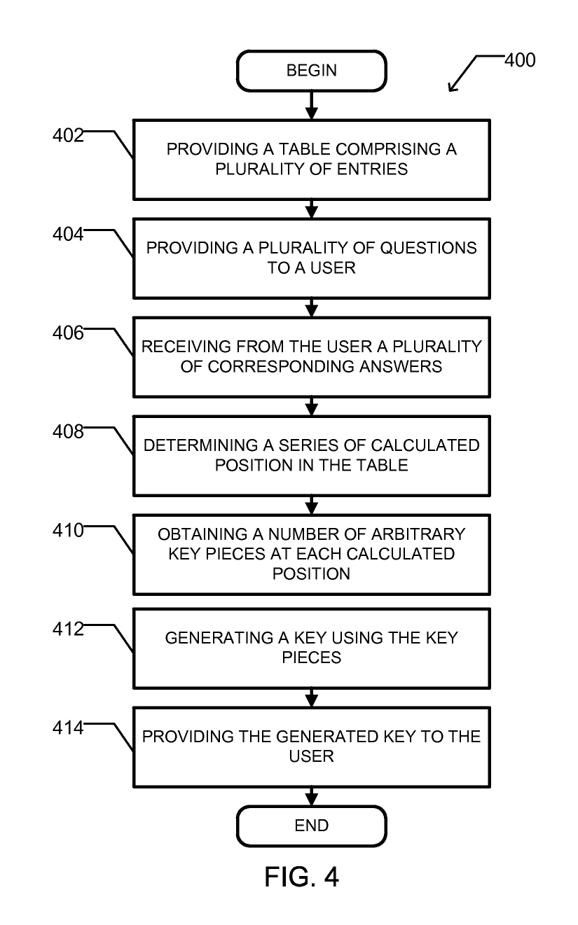

Now referring to FIG. 4, there is shown another embodiment of a method for retrieving a key from a table.

According to processing step 402, the same table, comprising a plurality of entries that is provided in processing step 302, is provided.

According to processing step 404, the same plurality of questions provided in processing step 304 is provided.

According to processing step 406, a plurality of corresponding answers is received. The skilled addressee will appreciate that each corresponding answer is related to a corresponding question provided to the user in processing step 404 and must be equal to answers provided in step 306.

According to an optional processing step not shown in FIG. 4, each corresponding answer related to a corresponding question is normalized. It will be appreciated by the skilled addressee that the same algorithm disclosed above for performing the optional normalization must be used.

According to processing step 408, a series of calculated recovery hash positions are determined in the table, using the same algorithm referred in step 312. In a preferred embodiment, the position is determined according to the following algorithm: a digest is produced from the secrets answers and the contents of a calculated table cell. This digest is used to calculate a series of hash positions to recover the secret key fragments. Hashing algorithm resolves possible collisions with cells occupied by key fragments or other cells used in calculations. Each read position is marked and any further access to that cell will trigger the use of next free cell. This is referred to as circular progressive overflow technique and is disclosed for instance by Donald E. Knuth, “The art of computer programming, 3: Sorting and Searching”, (2^{nd} Ed.); Addison-Wesley, pp 513-558, (1998).

According to processing step 410, a key fragment is obtained at each calculated position.

According to processing step 412, a key is reconstructed using the key fragments. In one embodiment, the key is generated by combining each key fragment together. The skilled addressee will appreciate that even a bad answer will return a key and that this key will be a “lure key”. If used, this lure key will trigger standard security mechanisms blocking attacker access after few tries. The skilled addressee will appreciate that the algorithm will not expose a different logic if a bad answer is provided and a lure key is calculated.

According to processing step 414, the generated key is provided to the user.

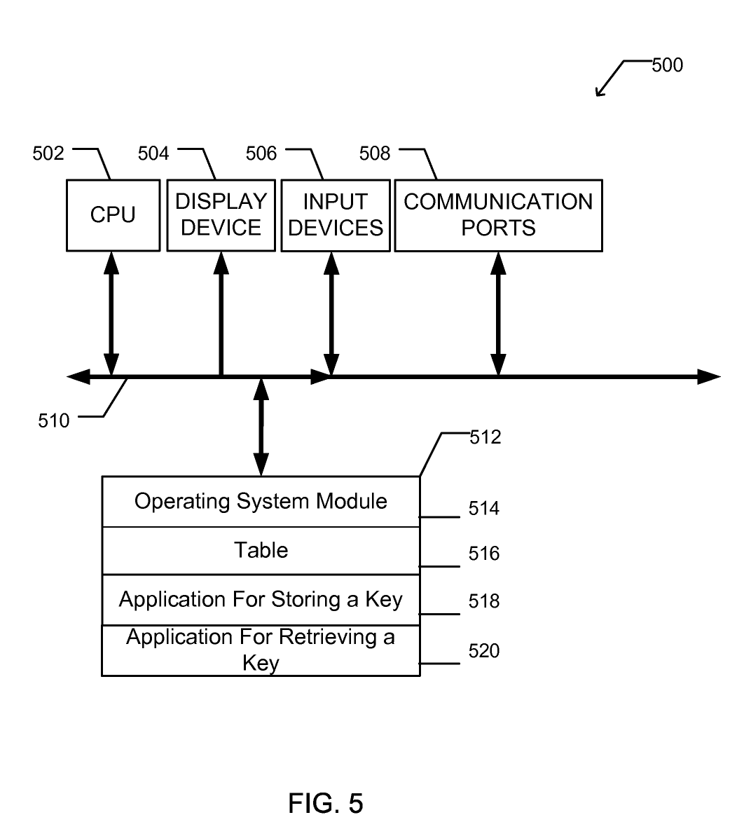

Now referring to FIG. 5, there is shown an embodiment of an apparatus 500 in which an embodiment of the method for storing a key in a table may be implemented and further wherein an embodiment of the method for retrieving a key from a table may be implemented.

The skilled addressee will appreciate that various alternative embodiments may be provided depending on various considerations departing from the scope of this application.

In this embodiment the apparatus 500 comprises a Central Processing Unit (CPU) 502, a display device 504, input devices 506, communication ports 508, a data bus 510 and a memory 512.

In a preferred embodiment, the central processing unit (CPU) 502 is used, inter alia, for processing an implementation of at least one part of the method disclosed herein. It will be appreciated that the central processing unit (502) may be a local processing unit. It may further be spit in parallel processing units, each processing unit doing a specific activity. Alternatively, an embedded logic solution may be provided. The skilled addressee will appreciate that various alternative embodiments may be possible for allowing to split table generation on an external highly secured unit and for performing parallel activities. Such alternative embodiment may accelerate key recovery and hiding.

Still in a preferred embodiment, the display device 504 is used for displaying various data to a user such as questions, data associated with the typing of the user, request for a user to perform a biometric scan, etc. The skilled addressee will appreciate that various alternative embodiments may be possible.

Still in a preferred embodiment, the input devices 506 comprise a mouse and a keyboard. The skilled addressee will appreciate that the mouse and the keyboard may be substituted by tactile displays or device specific keyboards, which could also host biometric readers such as fingerprint readers The skilled addressee will again appreciate that various alternative embodiments may be possible.

In a preferred embodiment, the communication ports 508 comprise means for enabling the providing of new random tables, means for enabling storage and recovery of hiding tables and means for accessing external autonomous devices such as biometric readers. The skilled addressee will appreciate that various alternative embodiments may be possible.

In a preferred embodiment, the data bus 510 is either a physical device connecting components or an implementation of a middleware enabling autonomous components to communicate. The skilled addressee will appreciate that various alternative embodiments may be possible.

In a preferred embodiment, the memory 512 is used for storing, inter alia, table data and as a size of 5 to 50 Mbytes, depending on hiding table sizes. The skilled addressee will appreciate that various alternative embodiments may be possible.

The Central Processing Unit 502, the display device 504, the input devices 506, the communication ports 508 and the memory 512 are operatively connected together using the data bus 510.

The input devices 506 are used for providing data to the apparatus 500.

The memory 512 is used for storing data.

More precisely and still in this embodiment, the memory 512 comprises, inter alia, an operating system module 514. In a preferred embodiment, the operating system module 514 may be a standard operating system, a mobile solution operating system or an embedded solution. The skilled addressee will appreciate that various alternative embodiments may be possible.

The memory 512 further comprises an application 518 for storing a key in a table 516.

The application 518 for storing a key in a table 516 comprises instructions for providing a table comprising a plurality of entries, each selected from a group consisting of random words and random strings.

The application 518 for storing a key in a table 516 further comprises instructions for providing a question to a user.

The application 518 for storing a key in a table 516 further comprises instructions for receiving from the user a corresponding secret answer.

The application 518 for storing a key in a table 516 further comprises instructions for receiving the key to store in the table.

The application 518 for storing a key in a table 516 further comprises instructions for determining a position in the table using the received corresponding secret answer and at least one table entry.

The application 518 for storing a key in a table 516 further comprises instructions for storing the key at the determined position.

The skilled addressee will appreciate that the application 518 for storing a key in the table 516 may be embedded in another application such as a security program for instance.

The memory 512 further comprises an application 520 for retrieving a key from the table 516.

More precisely, the application 520 for retrieving a key from the table 516 comprises instructions for obtaining the table 516.

The application 520 for retrieving a key from the table 516 further comprises instructions for providing the question to a user.

The application 520 for retrieving a key from the table 516 further comprises instructions for receiving from the user a corresponding secret answer to the question provided to the user.

The application 520 for retrieving a key from the table 516 further comprises instructions for determining a position in the table 516 using the received corresponding secret answer and at least one table entry of the table 516.

The application 520 for retrieving a key from the table 516 further comprises instructions for retrieving the key at the determined position.

The skilled addressee will appreciate that the application 520 for retrieving a key from the table 516 may be embedded in another application such as a security program for instance.

It will be appreciated that in an alternative embodiment, the application for storing a key in a table 516 may be implemented within the operating system module 514.

Also, it will be appreciated that a computer-readable media may be provided, the computer-readable media comprising instructions which when executed cause a method for storing a key in a table to be performed. The computer-readable media comprising instructions for providing a table comprising a plurality of entries, each selected from a group consisting of random words and random strings. The computer-readable media further comprising instructions for providing a question to a user. The computer-readable media further comprising instructions for receiving from the user a corresponding secret answer. The computer-readable media further comprising instructions for receiving the key to store in the table. The computer-readable media further comprising instructions for determining a position in the table using the received corresponding secret answer and at least one table entry. The computer-readable media further comprising instructions for storing the key at the determined position.

Also it will be appreciated that a computer-readable media may be provided, the computer-readable media comprising instructions which when executed cause a method for retrieving a key from a table to be performed.

The computer-readable media comprising instructions for obtaining a table generated in accordance with the method disclosed above.

The computer-readable media comprising instructions for providing a question to a user.

The computer-readable media further comprising instructions for receiving from the user a corresponding secret answer to the question provided to the user.

The computer-readable media comprising instructions for determining a position in the table using the received corresponding secret answer and at least one table entry of the table generated.

The computer-readable media further comprising instructions for retrieving the key at the determined position.

Although the above description relates to a specific preferred embodiment as presently contemplated by the inventor, it will be understood that the invention in its broad aspect includes mechanical and functional equivalents of the elements described herein.

1. A method for storing a key in a table, the method comprising:
providing a table comprising a plurality of entries, each selected from a group consisting of random words and random strings;
providing a question to a user;
receiving from the user a corresponding secret answer;
receiving the key to store in the table;
determining a position in the table using the received corresponding secret answer and at least one table entry; and
storing the key at the determined position.

2. The method as claimed in claim 1, wherein the key is used as a password to grant access to a system.

3. The method as claimed in claim 1, wherein the key is used for encrypting a message according to a private key encryption system.

4. The method as claimed in claim 1, wherein the key comprises a sequence of characters.

5. The method as claimed in claim 1, wherein each entry of the plurality of entries is selected from a group consisting of random words and random strings.

6. The method as claimed in claim 1, wherein each entry of the plurality of entries is selected from a group consisting of syllabi and phonemes of at least one language.

7. The method as claimed in claim 1, further comprising normalizing the received secret answer, further wherein the position in the table is determined using the normalized received corresponding answer and at least one table entry.

8. The method as claimed in claim 7, wherein the normalizing the received secret answer comprises at least one of setting a unique case; reducing spaces, blank characters and uncommon characters to one space and substituting common expressions in the received secret answer.

9. The method as claimed in claim 1, wherein the key to store in the table is received by a user.

10. The method as claimed in claim 1, wherein the key to store in the table is received from an application.

11. The method as claimed in claim 1, wherein the determining of the position in the table comprises:
determining a table cell;
producing a digest using the corresponding secret answer and content located in the determined table cell;
using the digest to calculate the position.

12. The method as claimed in claim 11, wherein a plurality of positions are calculated using the digest, further comprising breaking the key to store in a plurality of key fragments, each of the plurality of key fragments being stored in a corresponding position of the plurality of position.

13. The method as claimed in claim 1, wherein a plurality of questions are provided to a user; further wherein a plurality of corresponding secret answers are received from the user;
further wherein a plurality of positions are determined in the table, each using at least one received corresponding secret answer and at least one entry; further comprising breaking the key to store in a plurality of key fragments, each of the plurality of key fragment being stored in a corresponding position of the plurality of positions.

14. A method for retrieving a key from a table, the method comprising:
obtaining a table generated to comprise a plurality of entries, each selected from a group consisting of random words and random strings;
providing the question to a user;
receiving from the user a corresponding secret answer;
determining a position in the table using the received corresponding secret answer and at least one table entry of the table generated; and
retrieving the key at the determined position.

15. A method for retrieving a key from a table, the method comprising:
obtaining a table generated to comprise a plurality of entries, each selected from a group consisting of random words and random strings;
providing the question to a user;
receiving from the user a corresponding secret answer;
normalizing the corresponding secret answer;
determining a position in the table using the corresponding normalized secret answer and at least one table entry of the table generated;
further comprising normalizing the received secret answer, further wherein the position in the table is determined using the normalized received corresponding answer and at least one table entry and
retrieving the key at the determined position.

16. A method for retrieving a key from a table, the method comprising:
obtaining a table generated to comprise a plurality of entries, each selected from a group consisting of random words and random strings;
providing the plurality of questions to the user, wherein a plurality of questions are provided to a user; further wherein a plurality of corresponding secret answers are received from the user; further wherein a plurality of positions are determined in the table, each using at least one received corresponding secret answer and at least one entry; further comprising breaking the key to store in a plurality of key fragments, each of the plurality of key fragment being stored in a corresponding position of the plurality of positions;
receiving from the user a corresponding plurality of secret answers;
determining a plurality of positions in the table using the corresponding plurality of secret answers and at least one entry on the table;
retrieving a part of the key at each of the plurality of positions;
combining each part of the key to provide the key.

17. A program storage device readable by a machine, embodying a program of instructions executable by the machine to perform a method, the method comprising:
providing a table comprising a plurality of entries, each selected from a group consisting of random words and random strings;
providing a question to a user;
receiving from the user a corresponding secret answer;
receiving the key to store in the table;
determining a position in the table using the received corresponding secret answer and at least one table entry; and
storing the key at the determined position.

18. A program storage device readable by a machine, embodying a program of instructions executable by the machine to perform a method, the method comprising:
obtaining a table generated to comprise a plurality of entries, each selected from a group consisting of random words and random strings;
providing the question to a user;
receiving from the user a corresponding secret answer;
determining a position in the table using the received corresponding secret answer and at least one table entry of the table generated; and
retrieving the key at the determined position.

19. A computing device, comprising:
a display device;
a central processing unit;
a memory comprising an application, wherein the application is configured to be executed by the central processing unit, the application comprising:
instructions for providing a table comprising a plurality of entries, each selected from a group consisting of random words and random strings;
instructions for providing a question to a user;
instructions for receiving from the user a corresponding secret answer;
instructions for receiving the key to store in the table;
instructions for determining a position in the table using the received corresponding secret answer and at least one table entry; and
instructions for storing the key at the determined position.

20. The method as claimed in claim 1, wherein the secret answer comprises at least one of a corresponding response to the question and user biometric data.

21. The method as claimed in claim 20, wherein the secret answer comprises user biometric data, further wherein the user biometric data is selected from a group consisting of fingerprint data, iris data and typing pattern data.

22. The method as claimed in claim 13, wherein each of the plurality of corresponding secret answers comprises at least one of a corresponding response to a corresponding question and user biometric data.
